(19) United States
(12) Patent Application Publication
(10) Pub. No.: US 2014/0156511 A1
(43) Pub. Date: Jun. 5, 2014

(54) METHOD AND APPARATUS FOR PROVIDING EXCHANGE OF GIFT CARDS

(71) Applicant: Dahai Ren, Lincoln, MA (US)

(72) Inventor: Dahai Ren, Lincoln, MA (US)

(73) Assignee: Verizon Patent and Licensing Inc., Basking Ridge, NJ (US)

(21) Appl. No.: 13/693,646

(22) Filed: Dec. 4, 2012

(51) Int. Cl. G06Q 20/34

(52) U.S. Cl. CPC G06Q 20/348
USPC 705/39

(57) ABSTRACT

An approach for a way to exchange gift cards (as well as other incentives, such as coupons) in a fair, efficient and secure environment. A first gift card information associated with a first merchant is received. The gift card information and user request information are evaluated to determine an exchange value. A second gift card information associated with a second merchant is determined based upon the exchange value.

### BACKGROUND INFORMATION

Gift cards have grown in popularity because of the convenience and security concerns over cash. Gift cards are generally received from a third-party and are associated with certain retailers or service providers. Such cards may also be in the form of open-loop cards issued by banks or credit card companies. Unfortunately, the beneficiary of the gift card may not need or want anything from that specified retailer. The recipient is left having to manage unwanted gift cards. Consequently, the gift may remain unused and potentially forgotten after some lapse of time. Alternatively, the receiver may simply “re-gift” or sell the card to another party. Under these circumstances, the giver and receiver of the gift do not receive any satisfaction. Moreover, the retailers (issuers of the cards) do not benefit from incentivizing willing customers to consume their products and services.

Based on the foregoing, there is a need for an approach to exchange gift cards effectively and efficiently.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system utilizing a card exchange manager, according to one embodiment;

FIG. 2 is a diagram of a card exchange manager capable of exchanging cards associated with different issuers, according to one embodiment;

FIGS. 3A and 3B are flowcharts of a process to exchange gift cards involving the card exchange manager of FIG. 2, according to one embodiment;

FIG. 4 is a flowchart of a process for a user device to enter a virtual gift card exchange place, according to one embodiment;

FIGS. 5 and 6 are diagrams of an exemplary network architecture of systems for exchanging cards associated with different merchants, according to certain embodiments;

FIG. 7 is a diagram of a computer system that can be used to implement various exemplary embodiments; and

FIG. 8 is a diagram of a chip set that can be used to implement various exemplary embodiments.

### DESCRIPTION OF THE PREFERRED EMBODIMENT

An apparatus, method, and software for providing exchange of gift cards are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to a way to exchange gift cards, it is contemplated that these embodiments have applicability to other merchant product exchanges as well as reward incentives (e.g., reward cards, coupons, etc.).

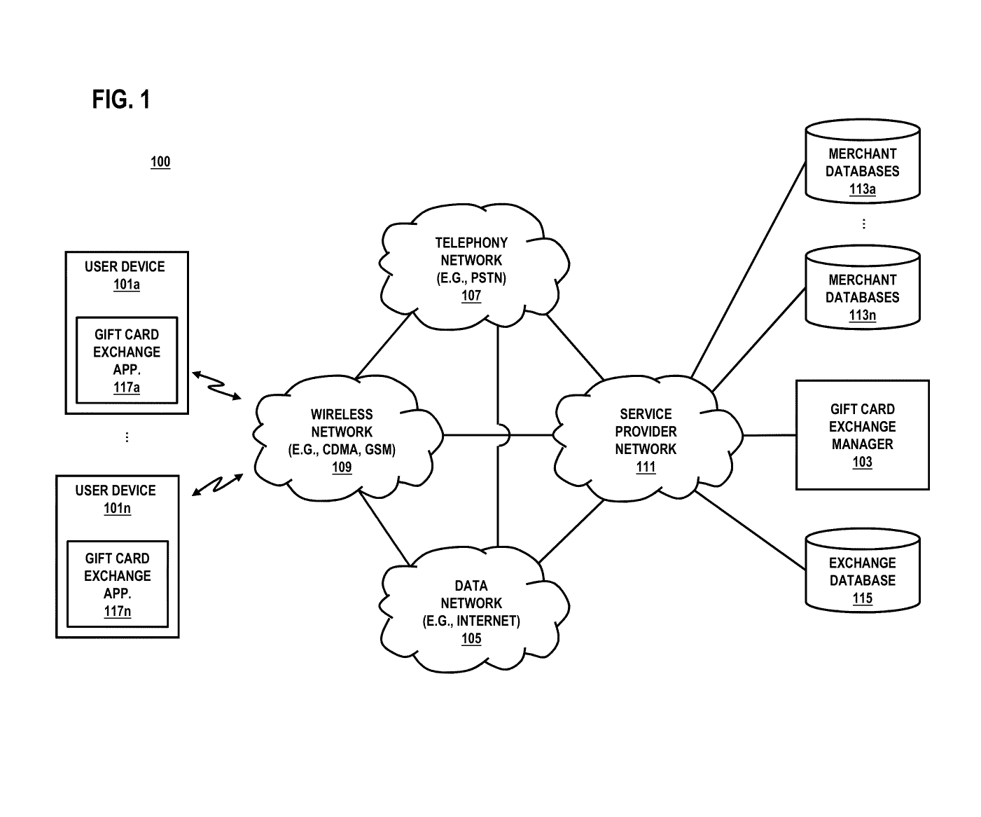

FIG. 1 is a diagram of a system utilizing a card exchange manager, according to one embodiment. For the purpose of illustration, the system 100 may include one or more user devices (e.g., user devices 101a-101n, etc.) with card exchange application (e.g., 117a-117n, etc.) that may be utilized to access card exchange services (e.g., as provided by exchange manager 103) over one or more networks (e.g., data network 105, telephony network 107, wireless network 109, service provider data network 111, etc.). The gift card exchange service may be presented as a marketplace or “exchange place” in which the users (subscribers) are presented with a forum to view potential cards to exchange with and to submit gift cards to be traded in. In one embodiment, the service can exchange coupons in addition (or in the alternative) to gift cards. It is noted that such applications can also be eliminated, and implemented via browser accessing a website; for example; such website can be part of the card exchange manager 103. According to one embodiment, these services may be included as part of managed services supplied by a service provider (e.g., a wireless communication company) as a hosted or a subscription-based service made available to users of the user devices 101 through the service provider data network 111. As such, the card exchange manager 103 may, for instance, be configured to aid in a secure transaction between users. In this regard, exchange manager 103 may provide more secure and efficient transactions between parties interested in gift card exchanges. As noted, the data services, in certain embodiments, conform with the Institute of Electrical and Electronics Engineers (IEEE) 802.3 standards.

As used herein, a “gift card” refers to either a physical or virtual card that is associated with a monetary value that can be used to purchase or otherwise acquire products or services from a retailer (or merchant). The terms, retailer and merchant, are used interchangeably to refer to an entity that offers goods and/or services. In certain embodiments, a gift card is issued by a retailer and is assigned a certain cash value (e.g., $50 card, $100 card, etc.). The gift card may also be in form of a reward card whereby a point system is used instead of a cash-based system, in which the redeemer can use the points to obtain goods and services.

As shown, the card exchange manager 103 may be part of or connected to the service provider network 111. In certain embodiments, the card exchange manager 103 may include or have access to merchant databases 113a-113n and an exchange database 115. The merchant databases 113a-113n, in some embodiments, store data needed to validate and manage gift cards with respect to the outputs of the card exchange manager 103. In one embodiment, these databases 113a-113n may be part of the respective merchant's systems.

The exchange database 115 may, for instance may be utilized to access or store user information, such as user identifiers, passwords, device information associated with users, user access data, etc. and/or gift card information, such as card identifiers, merchants associated with such cards, etc. While specific reference will be made thereto, it is contemplated that the system 100 may embody many forms and include multiple and/or alternative components and facilities. In addition, although various embodiments are described with respect to gift cards in mind it is contemplated that the approach described herein may be used with other digital property, operations, administration, and management standards or techniques.

It is recognized that in the exchange of gift cards, preserving security can be a challenge in that the parties have the ability to use gift cards prior to their physical trade. That is, the user may make certain purchases that reduce the monetary values associated with the card. For example, a $50 gift card from Merchant A is used fully or partially, and thus, should not be readily exchanged with a $50 gift card (with the full $50 being unused) from Merchant B. From the standpoint of the users, the remaining values of the cards are not known unless they visit the respective merchants to scan the cards. Without verification by the associated merchant and similar or identical valuation, a safe and secure exchange is impossible. With the advent of the ability to use gift cards online without a physical card, such exchange becomes even more tenuous.

To address the above issues, the system 100 of FIG. 1 provides the capability to facilitate, in a safe and secure manner, the secure and accurate exchange of gift cards. The system 100 can also provide for exchanges involving greater than two cards with differing values. By way of example, a user can launch, via user device 101a, card exchange application 117a to request an exchange of a card associated with a first merchant. Under this scenario, the card exchange application 117a communicates with the card exchange manager 103 to provide gift card information associated with a first merchant. Also, another user of user device 101n, via card exchange application 117n, seeks to trade-in a card associated with a second merchant, and supplies the associated gift card information to card exchange manager 103. In this example, user devices 101a, 101n are mobile devices (e.g., smartphones, netbooks, laptops, etc.) that may also be configured to utilize a browser to communicate with the card exchange manager 103. Among other functions, the card exchange manager 103 validates the cards and their values using the corresponding merchant databases 113a, 113n. Thereafter, the card exchange manager 103 executes an exchange procedure to locate a matching merchant for the respective request. Under this scenario, it is assumed that user of device 101a has a card that user of device 101n seeks, and vice versa. In effect, the card exchange manager 103 has found a match. Alternatively or additionally, the requester may specify the desired gift card among multiple exchange options (e.g., other gift cards posted by other users/subscribers) provided by the card exchange manager 103. It is contemplated that the matching process can occur in real-time, whereby the card exchange manager 103 continually seek users who are on-line with the desired card of the requesting user. Alternatively, card exchange manager 103 may “wait” for an appropriate match for a predetermined duration. In yet another embodiment, the service provider may have agreements in placed with the participating merchants to accept trade-in cards from other merchants in advance of finding a match; that is, reconciliation of the cards can occur independently from the processing of satisfying requests for card exchanges.

At this point, new cards may be reissued to the requesting users. Such reissuance may involve sending of new physical gift cards to the corresponding users or virtual gift cards (e.g., store credit, particularly if the requesting user has an account with the desired merchant). The old or original gift cards can then be rendered void; whereby, in one embodiment, card exchange manager 103 communicates with the respective merchant systems (not shown) to convey that the original gift cards are no longer valid. As described, manager 103 can apply exchange services to other incentives, such as coupons,

In one use case, the digital property is a unique coupon code, having the ability to only be redeemed one time by a customer. This coupon code then has similar properties to a gift card in that the coupon would lose its original value on its first use; hence, security involved with an exchange of coupons can also be an issue. For example, a user 1 has a $50 off spending $200 purchase coupon from Merchant A that they hope to exchange with another user 2, for a 20% off spending $100 purchase coupon from Merchant B. Neither user knows whether the code was previously used by the other. In other use cases, the digital property is some kind of electronic media, such as music or video which might be authenticated by digital rights management (DRM). Additionally, in other use cases the digital property exchanged may be of two different types such as gift card for a coupon, coupon for music or video, gift card for music or video, etc.

For illustrative purposes, the networks 105-111 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network. Wireless network 109 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 105-111 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that networks 105-111 may include components and facilities to provide for signaling and/or bearer communications between the various components or facilities of system 100. In this manner, networks 105-111 may embody or include portions of a signaling system 7 (SS7) network, or other suitable infrastructure to support control and signaling functions.

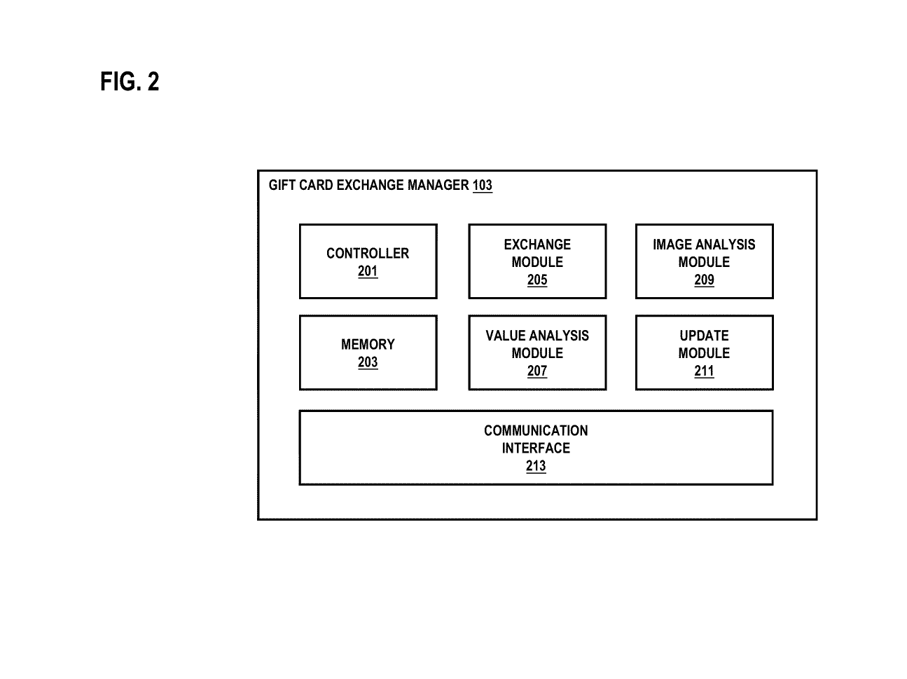

FIG. 2 is a diagram of a card exchange manager capable of exchanging cards associated with different issuers, according to one embodiment. By way of example the card exchange manager 103 includes one or more components for providing for secure, efficient gift card exchanges. It is contemplated that the functions of these components may be combined in one or more components or performed by other components of equivalent functionality. In this embodiment, exchange manager 103 includes controller 201, memory 203, an exchange module 205, a value analysis module 207, image analysis module 209, update module 211, and a communication interface 213.

The controller 201 may execute at least one algorithm (e.g., stored at the memory 203) for executing functions of the card exchange manager 103. For example, the controller 201 may interact with the exchange module 205 to best determine an exchange of gift cards based upon gift card information and user request information. The exchange module may work with the other modules to obtain and analyze such information in order to determine the best possible exchange.

In certain embodiments, the exchange module 205 may work with the image analysis module 209 to analyze a scanned, photographed, or otherwise inputted gift card to determine information such as assumed value, merchant, gift card number, etc. The information may be stored under gift card information which might be verified by merchants upon a later step. The transformation of a physical gift card to electronic data form in order to be analyzed and verified is necessary unless the information is already in an electronic data form.

In certain embodiments, the exchange module 205 may then operate with the value analysis module 207 to verify or determine the value of the gift card with the associated merchant in determining what exchanges might best be made. The value analysis module 207 communicates with the gift card information's associated merchant's system in order to verify the gift card information and for the exchange module 205 to determine that the exchange is valid or invalid (i.e., proper to perform). The gift card information is compared against the information for the gift card as found within the merchant system.

In certain embodiments, the exchange module 205 may operate with the exchange module 205 to best determine, e.g., based upon user requests, a set of exchanges that fulfills the most exchanges among users. As an example, 50 user requests are being processed, and the module 205 determines that two approaches are possible for a given time period: a 10 user exchange, and a 5 user exchange. The exchange module 205 can elect the exchange in which 10 users are involved as the best approach, even though the 5 user exchange may have yielded a greater total value of the exchanges (which may benefit certain merchants more, for instance). It is contemplated the exchange module 205 can apply various other criteria in addition to (or alternatively) in determining what is “best” or optimal; such criteria can include subscriber priority levels, transaction cost, total value of the coupons, merchant requirements, etc.

In certain embodiments, once an exchange has been decided upon by the exchange module 205, the update module 211 may be used to communicate with the merchant systems to issue a new gift card for the new owner of the gift card, while cancelling the previously received gift card information within the merchant systems to prevent further use by the original party. In this manner, the integrity of the exchange is maintained.

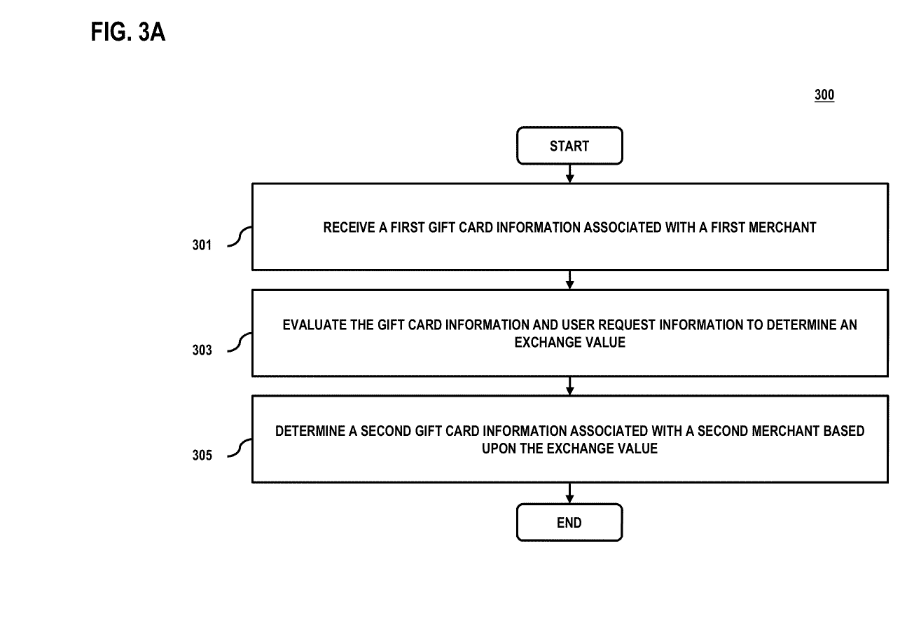

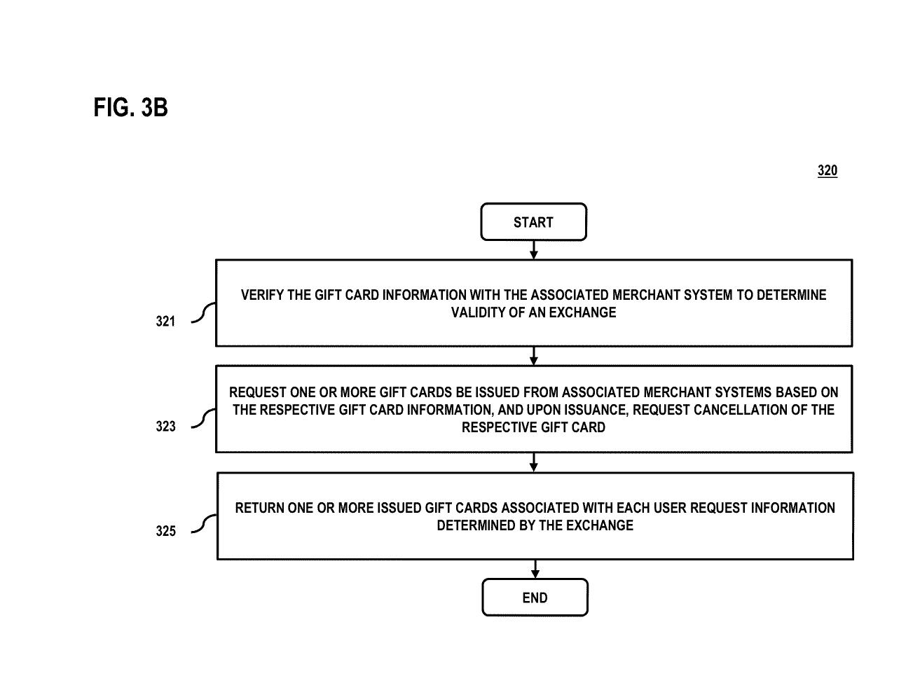

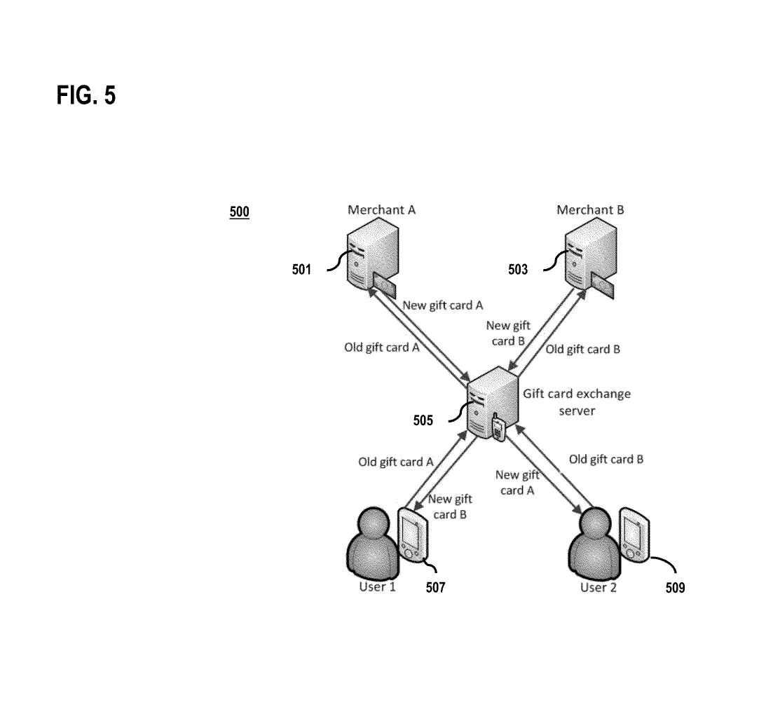

FIGS. 3A and 3B are flowcharts of a process to exchange gift cards involving the card exchange manager of FIG. 2, according to one embodiment. For the purpose of illustration, process 300 is described with respect to FIG. 1. It is noted that the steps of the process 300 may be performed in any suitable order, as well as combined or separated in any suitable manner. As shown in FIG. 3A, in step 301 the card exchange manager 103 may receive a first gift card information associated with a first merchant. This request may originate from the user of user device 101a via card exchange application 117a or a web browser. The first gift card information, for instance, may include information such as value, associated merchant, gift card identification number, expiration date, etc. As will be explained with respect to FIG. 5, the gift card information may be provided as a scanned image or a picture of the gift card (e.g., as captured by a camera of smartphone).

In step 303, the card exchange manager 103 evaluates the gift card information and user request information to determine an exchange value. The exchange value may simply be the monetary value on the card or created by a more sophisticated scheme that can account for merchants that are more desirable as well as any differences in value due to other factors, such as exchange rate, geography, etc. In one embodiment, the gift card information includes information such as value, associated merchant, expiration date, and gift card identification number. Other fields or different fields may be utilized, depending on the specific implementation. In certain embodiments, the user request information is specified by the user and may include information about the particular merchant gift cards of interest to the user, values they would exchange for, and/or users they might exchange with. Such criteria may be learned through social networking applications; e.g., the users may wish to exchange cards with their own social group or on-line user communities.

In step 305, the card exchange manager 103 determines a second gift card information associated with a second merchant based upon the exchange value. In certain embodiments, the second gift card information might be based on stored gift cards with exchange values of the first gift card information merchant, or the card exchange manager 103 will find a proper exchange condition based on the exchange values. By way of example, the exchange values are compared against the first gift card information and second gift card information to validate an exchange (if they match). Otherwise, if no exchange is found, the gift card information may be saved and published for future exchange.

Per FIG. 3B, process 320 is described with respect to FIG. 1. It is noted that the steps of the process 320 may be performed in any suitable order, as well as combined or separated in any suitable manner. In step 321, process 320, as executed by the card exchange manager 103, may verify the gift card information with the associated merchant system to determine validity of an exchange. In certain embodiments, the verification compares the gift card information received with information from the associated merchant system. If the gift card information matches, the process 320 validates the exchange. Otherwise, the exchange is determined to be invalid.

In step 323, the card exchange manager 103 requests one or more gift cards be issued from the associated merchant systems based on the respective gift card information. Upon acceptance and issuance of the new cards, process 320 can initiate the cancellation of the respective gift cards. In certain embodiments, the gift cards issued by the merchant systems return the different gift card identification numbers, (leaving all other gift card information the same). Furthermore, the old or original gift card is then cancelled from the merchant system in order to maintain the integrity of the exchange.

In step 325, the card exchange manager 103 returns one or more issued gift cards associated with each user request information determined by the exchange. In certain embodiments, once the merchant system issue a new gift card, the new gift card information is sent to the user who requested the gift card from each merchant respectively.

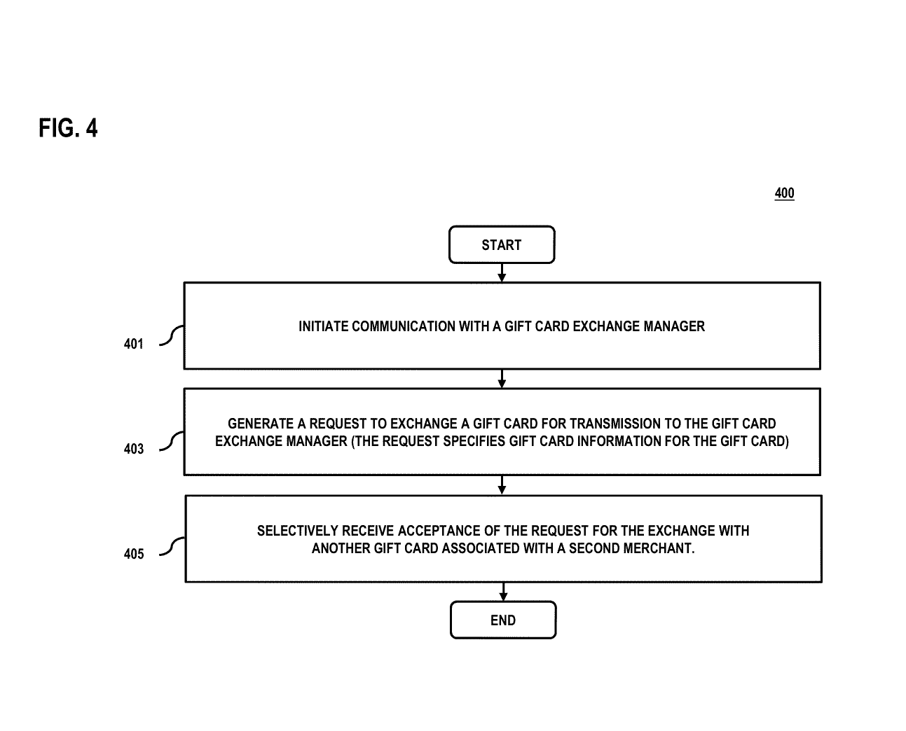

FIG. 4 is a flowchart of a process for a user device to enter a virtual gift card exchange place, according to one embodiment. Continuing with the example of FIG. 1, user device 101a can execute process 400 (which is a part of card exchange application 117a). In step 401, the process 400 initiates communication with gift card exchange manager 103. Alternatively, such communication may be provided using a web browser, for instance. Next, per step 403, a request is generated to exchange a gift card, whereby the request is transmitted to the gift card exchange manager 103. The request specifies gift card information for the gift card that is associated with a first merchant. Card exchange application 117a then selectively receives acceptance of the request, by the gift card exchange manager 103, for the exchange with another gift card associated with a second merchant (per step 405). The acceptance is contingent upon proper verification and validation of the subject gift card. It is noted that the process 400 can also include collecting information about the gift card by capturing an image of a physical representation of the card. The collected information is thereafter supplied to the gift card exchange manager 103. The card exchange application 117a and associated interface supported by device 101a may present one or more exchange options (which may include an exchange for the other gift card associated with the second merchant).

Although the processes of FIGS. 3 and 4 are described with respect to a one for one exchange of a gift card, it is contemplated that a single gift card may be traded in for multiple gift cards from multiple merchants/retailers. Additionally, coupons may be utilized in lieu of or in addition to gift cards.

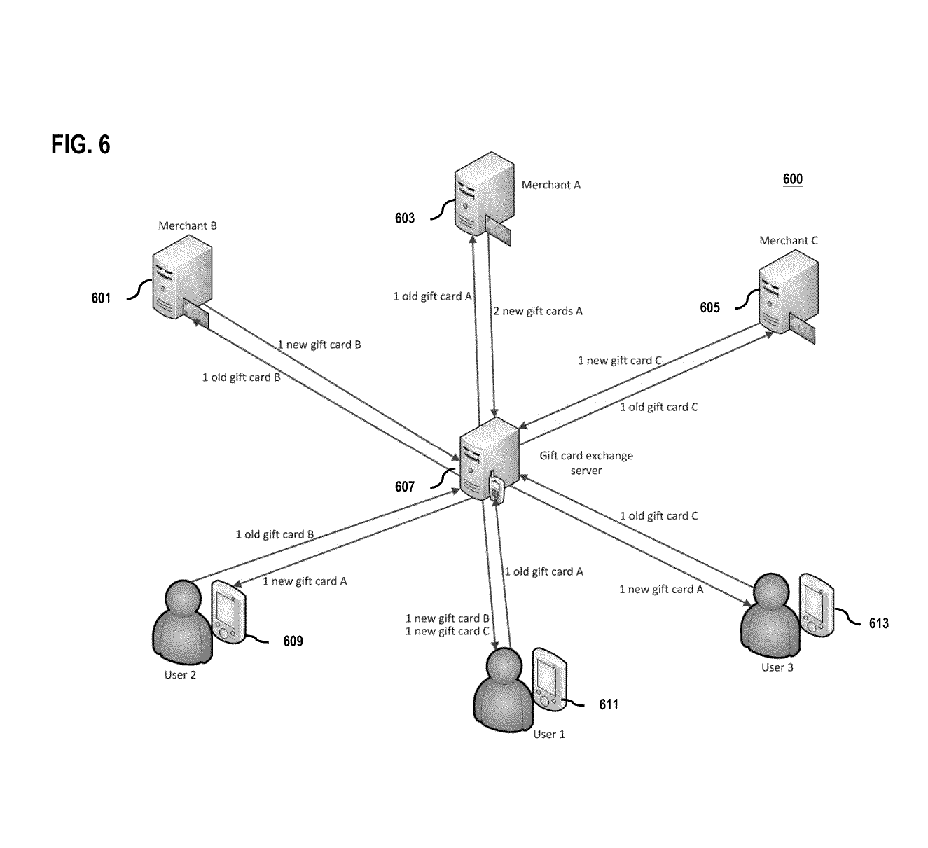

FIGS. 5 and 6 are diagrams of an exemplary network architecture of systems for exchanging cards associated with different merchants, according to certain embodiments. For the purpose of illustration, system 500 can execute the processes of FIGS. 3 and 4 in a server-based system, whereby the card exchange manager 103 (of FIG. 1) is implemented as a server, which may be a web server. As shown in FIG. 5, the Merchant A (using system 501), and Merchant B (using system 503), communicate and relay gift card information to the exchange server 505. This server 505 further communicates and relays gift card information to user 1 and user 2 via their respective mobile devices (e.g., smartphones) 507 and 509. The exchange server 505 aids in the process of exchanging gift cards between two users by verifying and validating an exchange, and updating gift cards so no further use may be had by the previous owners.

In one embodiment, User1 has a $20 gift Card A, issued by MerchantA. User1 wants to trade for gift card issued by MerchantB; that is, Card B would be the target of the exchange (which will be determined by card exchange server 505). User1, using device 507, logs onto the exchange server 505 from the mobile client and scans both sides of the gift Card A (or one side, assuming sufficient identifying information exists for proper verification and validation by the particular merchant system). The gift card information, as represented by the scanned images, is then submit to the exchange server 505. The exchange server 505 then accepts the trade request from User1 and publishes it on an exchange place or marketplace to be viewed by other users.

Subsequently, User2 logs into the exchange server 505 and browses the published exchanges and decides that he/she wants to exchange for gift Card A. Thus, User2 scans his/her gift Card B for submission to the exchange server 505 for participation in the marketplace.

Next, the exchange server 505 accepts the trade request from User2, and verifies the values of gift Card A and Card B with their associated respective Merchants A and B. The exchange server 505 then requests and receives a new electronic gift Card A and new electronic gift Card B from the respective Merchants A and B. Systems 501 and 503 of merchants A and B, respectively, are notified to cancel or void the original gift cards. Thereafter, the new gift Card A can be saved under User2's trading account, and new gift Card B is saved under User1's 507 trading account. These trading accounts can be established as part of the card exchange service. Alternatively, users can participate in a one-time transaction, whereby a guest account utilized assigned.

As seen in FIG. 6, more users and additional merchants can be involved, as compared to the scenario of FIG. 5. In particular, any number of merchants and users may subscribe to the card exchange service. System 600 provides for merchant systems 601 (Merchant A), 603 (Merchant B), and 605 (Merchant C). The merchant systems 601, 603, and 605 establish communications with a gift card exchange server 607 to provide gift card information. As in the case of system 500, the users (e.g., User1, User2, and User3) can log onto the exchange server 607 to enter the exchange place using their respective mobile devices 609, 611, and 613. In this manner, the users can post their respective gift cards, Card A, Card B, and Card C, for exchange among all the users. These gift cards then verified and validated as previously discussed to ensure that such cards can be traded with its stated value (and not depleted) and were legitimately issued by the corresponding merchants. Thereafter, the gift cards are available for posting with the exchange place.

In one embodiment, User1 has a $50 gift Card A, issued by merchant, and seeks to trade it for gift Card B and Card C. User2 posses a $20 gift Card B (which may be issued by a different merchant than that of Card A). User1 logs onto the exchange server 607 from a mobile client of device 611, which is used to capture the image of gift Card A. The image is forwarded to the exchange server 607 for processing. The exchange server 607 then accepts the trade request from User1, publishing it on the exchange place. User2 browses the published exchanges on card exchange server 607, and has interest in exchanging for a gift card from Merchant A. User2 can then supply information from gift Card B either by capturing the image or manual input. Moreover, User3 has a $30 gift Card C that the user seeks to exchange for a gift card from Merchant A. Gift card information of Card C is provided to the exchange server 607 via device 613.

At this point, the exchange server 607 accepts the trade request from user 2 and User3 613, and verifies the values of the gift cards, Card A, Card B, and Card C with their associated respective Merchants A, B, and C. The exchange server 607 then requests and receives new electronic gift Card A1, new Card A2, new Card B, and new Card C from the associated respective Merchants A, B, and C. It is contemplated that such electronic submission of the new gift can be followed by transmission of the physical cards by the Merchants A, B, and C. The original traded-in cards are then voided by the various merchants. As discussed, the trades can be accounted for by the use of subscribers' trading accounts.

The systems and processes of FIGS. 1-6, in certain embodiments, advantageously permit the efficient and secure exchange of gift cards. Another advantage is that the service is robust as to accommodate different denominations. In this manner, the disadvantages of receiving unwanted gift cards are eliminated, thereby preserving the intent of the retailers/merchants for issuing the gift cards in the first instance.

The processes described herein for providing gift card exchange can be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

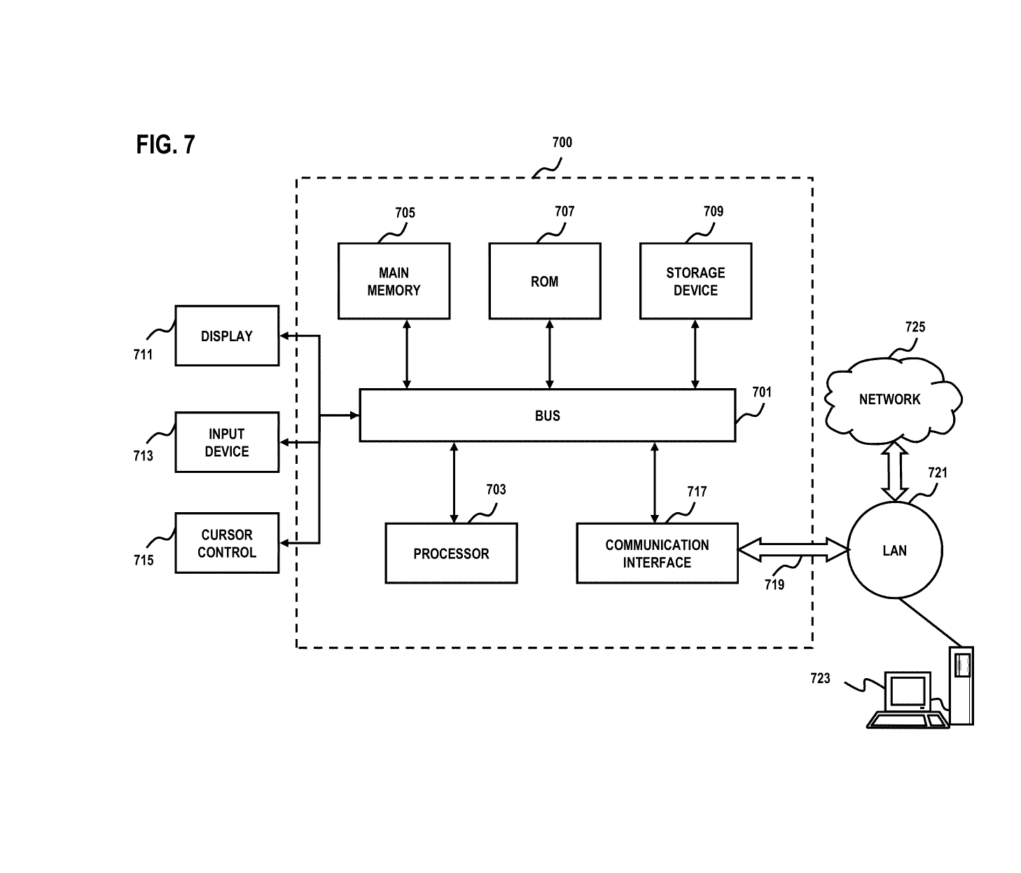

FIG. 7 illustrates computing hardware (e.g., computer system) upon which an embodiment according to the invention can be implemented. The computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 also can be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multiprocessing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

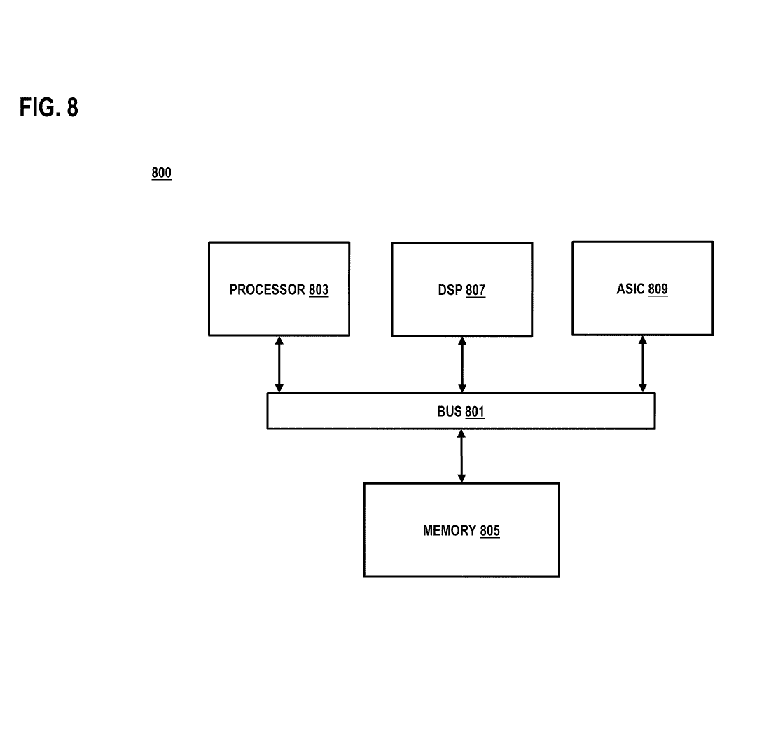

FIG. 8 illustrates a chip set 800 upon which an embodiment of the invention may be implemented. Chip set 800 is programmed to present a slideshow as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of FIGS. 3-6.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a first gift card information associated with a first merchant;
evaluating the gift card information and user request information to determine an exchange value; and
determining a second gift card information associated with a second merchant based upon the exchange value.

2. A method according to claim 1, further comprising:
verifying the gift card information with the associated merchant system to determine validity of an exchange.

3. A method according to claim 1, further comprising:
requesting one or more gift cards be issued from associated merchant systems based on the respective gift card information, and upon issuance, requesting cancellation of the respective gift card information.

4. A method according to claim 1, further comprising:
generating a prompt for user request information.

5. A method according to claim 4, the user request information comprising gift card value, gift card merchant, one or more user request merchants, and specific gift card exchange.

6. A method according to claim 1, further comprising:
storing and publishing gift card information to present to users as a plurality of exchange options.

7. A method according to claim 1, further comprising:
returning one or more issued gift cards associated with each user request information determined by the exchange.

8. An apparatus comprising:
a processor; and
a memory including computer program code for one or more programs,
the memory and the computer program code configured to, with the processor, cause the apparatus to perform at least the following,
receive a first gift card information associated with a first merchant;
evaluate the gift card information and user request information to determine an exchange value; and
determine a second gift card information associated with a second merchant based upon the exchange value.

9. An apparatus according to claim 8, wherein the apparatus is further configured to:
verify the gift card information with the associated merchant system to determine validity of an exchange.

10. An apparatus according to claim 8, wherein the apparatus is further configured to:
request one or more issued gift cards from associated merchant systems based on the respective gift card information, and
upon issuance, request cancellation of the respective gift card information.

11. An apparatus according to claim 8, wherein the apparatus is further configured to:
generate a prompt for user request information.

12. An apparatus according to claim 11, wherein the user request information comprises gift card value, gift card merchant, one or more user request merchants, and specific gift card exchange.

13. An apparatus according to claim 8, wherein the apparatus is further configured to:
store and publish gift card information to present to users as a plurality of exchange options.

14. An apparatus according to claim 8, wherein the apparatus is further configured to:
return one or more issued gift cards associated with each user request information determined by the exchange.

15. A method comprising:
initiating communication with a gift card exchange manager;
generating a request to exchange a gift card for transmission to the gift card exchange manager, the request specifying gift card information for the gift card that is associated with a first merchant; and
selectively receiving acceptance of the request for the exchange with another gift card associated with a second merchant.

16. A method according to claim 15, further comprising:
collecting information about the gift card by capturing an image of a physical representation of the card; and
providing the collected information to the gift card exchange manager.

17. A method according to claim 15, further comprising:
presenting one or more exchange options including an exchange for the other gift card associated with the second merchant.

18. An apparatus comprising:
a processor; and
a memory including computer program code for one or more programs,
the memory and the computer program code configured to, with the processor, cause the apparatus to perform at least the following,
initiate communication with a gift card exchange manager,
generate a request to exchange a gift card for transmission to the gift card exchange manager, the request specifying gift card information for the gift card that is associated with a first merchant, and
selectively receive acceptance of the request for the exchange with another gift card associated with a second merchant.

19. An apparatus according to claim 18, wherein the apparatus is further configured to:
collect information about the gift card by capturing an image of a physical representation of the card; and
provide the collected information to the gift card exchange manager.

20. An apparatus according to claim 18, wherein the apparatus is further configured to:
present one or more exchange options including an exchange for the other gift card associated with the second merchant.
